(19) United States
(12) Patent Application Publication
(10) Pub. No.: US 2024/0266619 A1
(43) Pub. Date: Aug. 8, 2024

(54) BATTERY PACK AND ELECTRIC DEVICE

(71) Applicant: Koki Holdings Co., Ltd., Tokyo (JP)

(72) Inventors: Satoshi YAMAGUCHI, Ibaraki (JP); Hiroyuki HANAWA, Ibaraki (JP)

(73) Assignee: Koki Holdings Co., Ltd., Tokyo (JP)

(21) Appl. No.: 18/566,091

(22) PCT Filed: Sep. 28, 2022
(86) PCT No.: PCT/JP2022/036106

§ 371 Date: Dec. 1, 2023

(30) Foreign Application Priority Data
Sep. 29, 2021 (JP) 2021-159136

(51) Int. Cl. H01M 10/42; B25F 5/02; H01M 10/48; H01M 50/204; H01M 50/247; H01M 50/51; H01M 50/512; H02J 7/00

(52) U.S. Cl. CPC H01M 10/425; H01M 10/482; H01M 10/488; H01M 50/204; H01M 50/247; H01M 50/51; H01M 50/512; B25F 5/02; H01M 2220/30; H02J 7/0029

(57) ABSTRACT

Provided is a battery pack and an electric device. The battery pack has a first circuit part connecting a positive electrode of an upper side cell unit and a power supply circuit, and a second circuit part connecting a negative electrode of a lower side cell unit and the circuit. In series connection state, a closed loop is formed by a positive electrode of the lower side cell unit, a lower side plus terminal, a shorting bar of a 36V device body, an upper side minus terminal, a negative electrode of the upper side cell unit, the positive electrode of the upper side cell unit, a diode, the circuit, and the negative electrode of the lower side cell unit. The circuit generates a power supply voltage using the series output voltage (36V) of the upper side and the lower side cell unit, and supplies the voltage to a control unit.

### BACKGROUND

### Technical Field

The invention relates to a battery pack and an electric device.

### Related Art

Patent Literature 1 listed below discloses a battery pack that is capable of switching the connection state of multiple cell units, and an electric device equipped with the same. Power supply voltage is supplied from a power supply circuit to a control unit of the battery pack. The power supply circuit is always connected to a specific cell unit among multiple cell units, and generates the power supply voltage for the control unit by the supplied power from the cell unit.

### CITATION LIST

### Patent Literature

[Patent Literature 1] WO 2018/230337

### SUMMARY

### Technical Problem

In the configuration of Patent Literature 1, since the power supply voltage of the control

unit is generated from a specific cell unit, an imbalance of voltages between this cell unit and other cell units easily occurs.

An object of the present invention is to provide a battery pack and an electric device capable of suppressing the occurrence of an imbalance of voltages in multiple cell units. Moreover, the invention also provides a battery pack and an electric device capable of supplying power supply voltage to the control unit from multiple cell units when the electric device body is connected. Further, it provides a battery pack and electric device that do not impair reliability even if a cell unit, a power supply circuit, or a part of the power supply circuit fails.

### Solution to Problem

One aspect of the present invention is a battery pack. The battery pack includes:
a first cell unit and a second cell unit, each having a plurality of battery cells connected in series with each other and configured to be capable of switching their connection states;
a control unit; and
a power supply circuit unit for supplying a power supply voltage to the control unit.

The battery pack has a first circuit part for connecting a positive electrode of a cell unit of one of the first cell unit and the second cell unit with the power supply circuit unit; and a second circuit part for connecting a negative electrode of a cell unit of the other of the first cell unit and the second cell unit with the power supply circuit unit.

Another aspect of the present invention is a battery pack. The battery pack includes:
a first cell unit and a second cell unit, each having a plurality of battery cells connected in series with each other and configured to be capable of switching between a series connection state of being connected in series with each other and a state other than the series connection;
a control unit; and
a power supply circuit unit for supplying a power supply voltage to the control unit.

The power supply circuit unit is configured to, in the series connection state, be electrically connected with a positive electrode of a cell unit of one of the first cell unit and the second cell unit and a negative electrode of a cell unit of the other of the first cell unit and the second cell unit and supply the power supply voltage to the control unit.

Another aspect of the present invention is a battery pack. The battery pack includes:
a plurality of cell units, each having a plurality of battery cells connected in series with each other and configured to be capable of switching between at least one of a series connection state of being connected in series with each other, a parallel connection state of being connected in parallel with each other, and a cut-off state of being separated from each other;
a control unit; and
a power supply circuit unit for supplying a power supply voltage to the control unit.

The power supply circuit unit is configured to, in the series connection state, be electrically connected with a positive electrode of a cell unit of the multiple cell units located at a highest voltage side and a negative electrode of the other cell unit located at a lowest voltage side and supply the power supply voltage to the control unit.

Another aspect of the present invention is a battery pack. The battery pack includes:
a first cell unit and a second cell unit, each having a plurality of battery cells connected in series with each other and configured to be capable of switching their connection states;
a control unit; and
a power supply circuit unit for supplying a power supply voltage to the control unit.

The battery pack is configured to change a connection mode of the power supply circuit unit, the first cell unit, and the second cell unit according to the connection state of the first cell unit and the second cell unit.

Another aspect of the present invention is a battery pack. The battery pack includes:
a first cell unit and a second cell unit, each having a plurality of battery cells connected in series with each other and configured to be capable of switching their connection states;
a first control unit and a second control unit respectively provided for the first cell unit and the second cell unit; and
a first power supply circuit unit and a second power supply circuit unit for supplying a power supply voltage to the first control unit and the second control unit respectively.

A ground potential of the first control unit and that of the second control unit are different.

The battery pack has a level shift circuit for responding to a difference in ground potential between the first control unit and the second control unit.

Another aspect of the invention is an electric device. The electric device includes:
an electric device body including a battery pack mounting part capable of mounting the battery pack, and a driving part driven by the battery pack mounted on the battery pack mounting part.

The “electric device” of the present invention may also be described as “working machine” or “power tool”, and such a description is also effective as aspects of the present invention.

### Effects

According to the present invention, it is possible to provide a battery pack and an electric device capable of suppressing the occurrence of an imbalance of voltages in a plurality of cell units. Moreover, it is also possible to provide a battery pack and an electric device capable of supplying the power supply voltage to the control unit from a plurality of cell units when the electric device body is connected. Moreover, it is possible to provide a battery pack and an electric device that do not impair reliability even if a cell unit, a power supply circuit, or a part of the power supply circuit fails.

### BRIEF DESCRIPTION OF THE DRAWINGS

FIG. 1 (A) is a schematic circuit block diagram of a battery pack 10 in a non-connection state according to embodiment 1 of the present invention. (B) is a schematic circuit block diagram of the battery pack 10 in a parallel connection state. (C) is a schematic circuit block diagram of the battery pack 10 in a series connection state.

FIG. 2 (A) is a schematic circuit block diagram of a battery pack 10A in a non-connection state according to embodiment 2 of the present invention. (B) is a schematic circuit block diagram of the battery pack 10A in a parallel connection state. (C) is a schematic circuit block diagram of the battery pack 10A in a series connection state.

FIG. 3 (A) is a schematic circuit block diagram of a battery pack 10B in a non-connection state according to embodiment 3 of the present invention. (B) is a schematic circuit block diagram of the battery pack 10B in a parallel connection state. (C) is a schematic circuit block diagram of the battery pack 10B in a series connection state.

FIG. 4 (A) is a schematic circuit block diagram of a battery pack 10C in a non-connection state according to embodiment 4 of the present invention. (B) is a schematic circuit block diagram of the battery pack 10C in a parallel connection state. (C) is a schematic circuit block diagram of the battery pack 10C in a series connection state.

FIG. 5 (A) is a schematic circuit block diagram of a battery pack 810 of a comparative example in a non-connection state. (B) is a schematic circuit block diagram of the battery pack 810 in a parallel connection state. (C) is a schematic circuit block diagram of the battery pack 810 in a series connection state.

FIG. 6 (A) is a schematic circuit block diagram of a battery pack 10D in a non-connection state according to embodiment 5 of the present invention. (B) is a schematic circuit block diagram of the battery pack 10D in a parallel connection state. (C) is a schematic circuit block diagram of the battery pack 10D in a series connection state.

FIG. 7 is a circuit block diagram of an electric device 1 that connects the battery pack 10 and an electric device body 30 to each other according to embodiment 6 of the present invention.

FIG. 8 is a circuit block diagram of an electric device 1A that connects the battery pack 10 and an electric device body 30A to each other according to embodiment 6 of the present invention.

FIG. 9 is a circuit block diagram of an electric device 1B that connects the battery pack 10 and an electric device body 30B to each other according to embodiment 6 of the present invention.

FIG. 10 (A) is a front view of the electric device 1. (B) is a side view of the electric device 1.

FIG. 11 is a perspective view of the battery pack 10.

FIG. 12 (A) is a schematic circuit block diagram of a battery pack 10H in a non-connection state according to embodiment 7 of the present invention. (B) is a schematic circuit block diagram of the battery pack 10H in a parallel connection state. (C) is a schematic circuit block diagram of the battery pack 10H in a series connection state.

FIG. 13 is a circuit block diagram of an electric device 1C that connects the battery pack 10H and the electric device body 30 to each other.

FIG. 14 (A) is a schematic circuit block diagram of a battery pack 10J in a non-connection state according to embodiment 8 of the present invention. (B) is a schematic circuit block diagram of the battery pack 10J in a parallel connection state. (C) is a schematic circuit block diagram of the battery pack 10J in a series connection state.

FIG. 15 (A) is a schematic circuit block diagram of the battery pack 10J in a non-connection state when a lower side cell unit 5 fails and becomes open. (B) is a schematic circuit block diagram of the battery pack 10J in a parallel connection state in the same case. (C) is a schematic circuit block diagram of the battery pack 10J in a series connection state in the same case.

FIG. 16 (A) is a schematic circuit block diagram of the battery pack 10J in a non-connection state when an upper side cell unit 4 fails and becomes open. (B) is a schematic circuit block diagram of the battery pack 10J in a parallel connection state in the same case. (C) is a schematic circuit block diagram of the battery pack 10J in a series connection state in the same case.

FIG. 17 (A) is a schematic circuit block diagram of the battery pack 10J in a non-connection state when a power supply circuit 3 fails and becomes open. (B) is a schematic circuit block diagram of the battery pack 10J in a parallel connection state in the same case. (C) is a schematic circuit block diagram of the battery pack 10J in a series connection state in the same case.

FIG. 18 (A) is a schematic circuit block diagram of the battery pack 10J in a non-connection state when a power supply circuit 103 fails and becomes open. (B) is a schematic circuit block diagram of the battery pack 10J in a parallel connection state in the same case. (C) is a schematic circuit block diagram of the battery pack 10J in a series connection state in the same case.

FIG. 19 is a circuit block diagram of an electric device 1D that connects the battery pack 10J and the electric device body 30 to each other.

FIG. 20 is a circuit diagram of the part of the battery pack 10J related to the selection of the power supply circuits 3 and 103 by a control unit 2.

FIG. 21 is a timing chart showing an operation example of the circuit of FIG. 20 in a series connection state;

FIG. 22 (A) to (D) are circuit diagrams showing examples 1 to 4 of level shift circuits.

### DESCRIPTION OF THE EMBODIMENTS

In the following, the same or equivalent constituent elements, components, etc. shown in the drawings are given the same reference numerals, and redundant descriptions are omitted where appropriate. The embodiments are examples rather than limitations of the present invention. All the features or combinations mentioned in embodiments are not necessarily essential to the invention.

### (Embodiment 1)

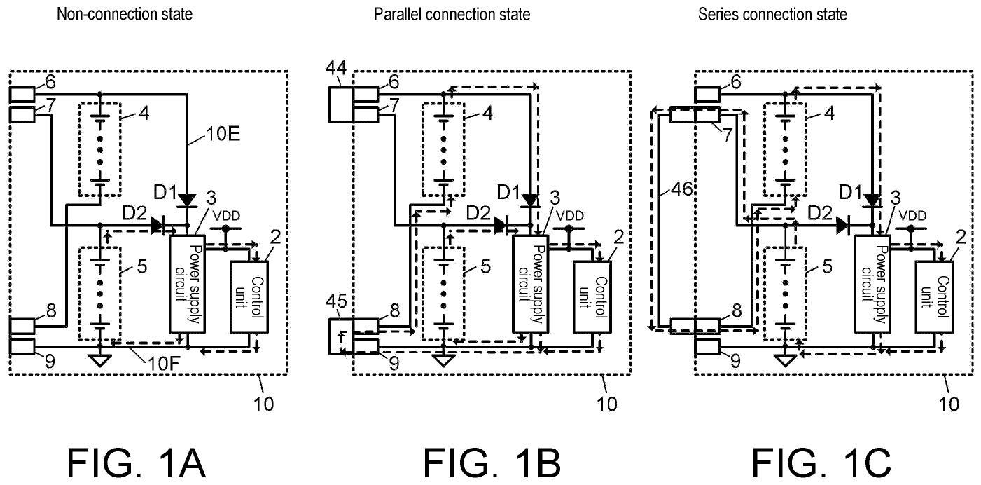

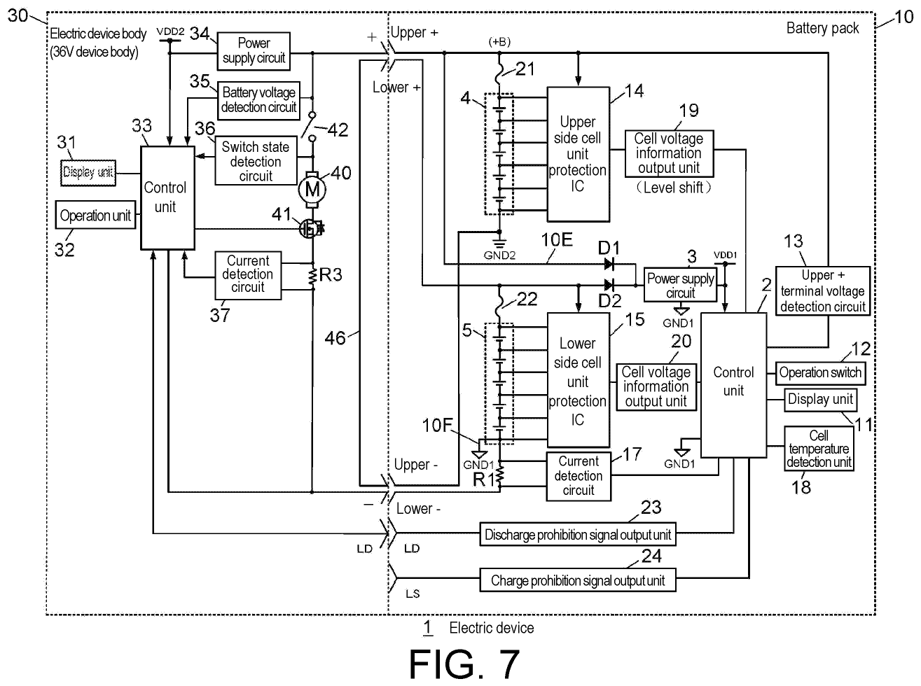

FIGS. 1 (A) to (C) relate to a battery pack 10 according to embodiment 1 of the present invention. FIGS. 1 (A) to (C) show the circuit block of the main parts of the battery pack 10. The entire circuit block including the battery pack 10 including parts other than the main parts is shown in the FIG. 7 to be described later. The battery pack 10 has a control unit 2, a power supply circuit 3 as a power supply circuit unit, an upper side cell unit 4 as a first cell unit, and a lower side cell unit 5 as a second cell unit.

The control unit 2 controls overall operation of the battery pack 10. Specifically, the control unit 2 controls the display of the remaining capacity of the battery pack 10, protects against abnormalities such as overcurrent, overdischarge, overcharge, and high temperature, and communicates with an electric device body (not shown) connected to the battery pack 10. The power supply circuit 3 supplies a power supply voltage VDD (for example, 5V) to the control unit 2.

The upper side cell unit 4 has multiple battery cells connected in series with each other. The lower side cell unit 5 has multiple battery cells connected in series with each other. Each battery cell is preferably a secondary battery cell. Here, as an example, the case where the rated output voltages of the upper side cell unit 4 and the lower side cell unit 5 are 18V will be described.

The battery pack 10 has, as terminals for connection to an electric device body, an upper side plus terminal 6 as a first plus terminal, a lower side plus terminal 7 as a second plus terminal, an upper side minus terminal 8 as a first minus terminal, and a lower side minus terminal 9 as a second minus terminal.

The upper side plus terminal 6 is connected to the positive electrode of the upper side cell unit 4. The lower side plus terminal 7 is connected to the positive electrode of the lower side cell unit 5. The upper side minus terminal 8 is connected to the negative electrode of the upper side cell unit 4. The lower side minus terminal 9 is connected to the negative electrode of the lower side cell unit 5.

The upper side cell unit 4 and the lower side cell unit 5 are configured to be switchable between a cut-off state where they are separate from each other as shown in FIG. 1 (A), a parallel connection state where they are connected in parallel with each other as shown in FIG. 1 (B) and a series connection state where they are connected in series with each other as shown in FIG. 1 (C).

The cut-off state shown in FIG. 1 (A) is a non-connection state in which the battery pack 10 is not connected to electric device body. In the non-connection state, the upper side plus terminal 6, the lower side plus terminal 7, the upper side minus terminal 8 and the lower side minus terminal 9 are all opened.

The parallel connection state shown in FIG. 1 (B) is a state in which the battery pack 10 is connected to an electric device body having a rated input voltage of 18V (hereinafter also referred to as “18V device body”). In the parallel connection state, the upper side plus terminal 6 and the lower side plus terminal 7 are connected (short-circuited) to each other through a plus terminal 44 of the 18V device body, and the upper side minus terminal 8 and the lower side minus terminal 9 are connected (short-circuited) with each other through a minus terminal 45 of the 18V device body. In the parallel connection state, the voltage between the plus terminal 44 and the minus terminal 45, namely the output voltage of the battery pack 10, is 18V.

The series connection state shown in FIG. 1 (C) is a state in which the battery pack 10 is connected to an electric device body having a rated input voltage of 36V (hereinafter also referred to as “36V device body”). In the series connection state, the lower side plus terminal 7 and the upper side minus terminal 8 are connected (short-circuited) with each other through a shorting bar 46 of the 36V device body. In the series connection state, the voltage between the upper side plus terminal 6 and the lower side minus terminal 9, namely the output voltage of the battery pack 10, is 36V. In the series connection state, the upper side cell unit 4 is a cell unit located on the high voltage side, and the lower side cell unit 5 is a cell unit located on the low voltage side.

The battery pack 10 has diodes D1 and D2 for preventing backflow. The anode of the diode D1 is connected to the positive electrode of the upper side cell unit 4. The anode of the diode D2 is connected to the positive electrode of the lower side cell unit 5. Cathodes of the diodes D1 and D2 are connected to the input terminal of the power supply circuit 3. The negative electrode of the lower side cell unit 5, the control unit 2 and each ground terminal of the power supply circuit 3 are grounded. That is, a first circuit 10E connecting the positive electrode of the upper side cell unit 4 and the power supply circuit 3 (input terminal of the power supply circuit 3) is formed on a circuit board (not shown) of the battery pack 10. Further, a second circuit 10F connecting the negative electrode of the lower side cell unit 5 and the power supply circuit 3 (the ground terminal of the power supply circuit 3) is formed. The first circuit 10E corresponds to the first circuit part of the present invention. The second circuit 10F correspond to the second circuit part of the present invention.

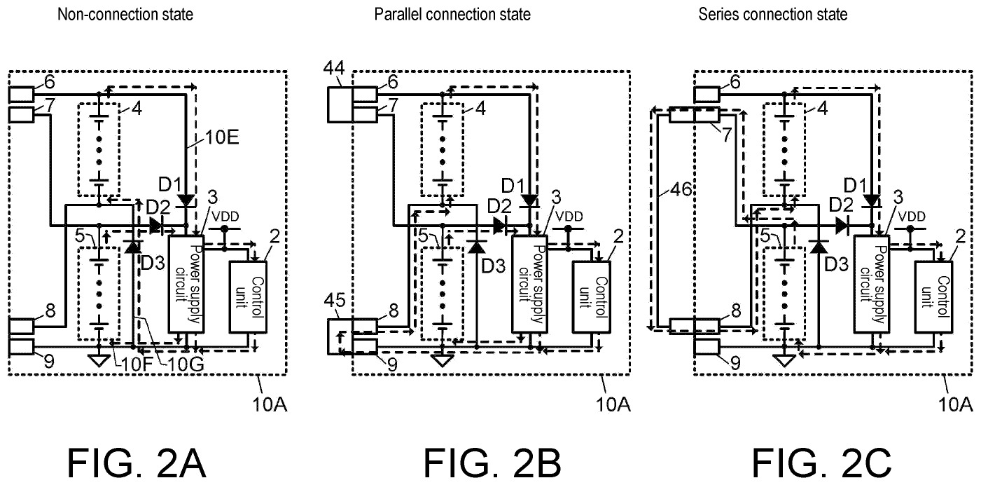

In FIGS. 1 (A) to (C), the flow of supplying power to the power supply circuit 3 and the flow of supplying power from the power supply circuit 3 to the control unit 2 are indicated by dashed arrows. The same applies to FIGS. 2 (A) to (C), 3 (A) to (C), 4 (A) to (C), 5 (A) to (C), 6 (A) to (C), 12 (A) to (C), 14 (A) to (C), 15 (A) to (C), 16 (A) to (C), 17 (A) to (C), and 18 (A) to (C), which will be described later.

In the cut-off state shown in FIG. 1 (A), a closed loop (hereinafter also referred to as “lower side closed loop”) of the positive electrode of the lower side cell unit 5, the diode D2, the power supply circuit 3, and the negative electrode of the lower side cell unit 5 is formed. The power supply circuit 3 generates the power supply voltage VDD through the output voltage (18V) of the lower side cell unit 5, and supplies it to the control unit 2. Since the negative electrode of the upper side cell unit 4 is opened, the output voltage of the upper side cell unit 4 is not involved in the generation of the power supply voltage VDD.

In the parallel connection state shown in FIG. 1 (B), in addition to the lower side closed loop, a closed loop of the positive electrode of the upper side cell unit 4, the diode D1, the power supply circuit 3, the lower side minus terminal 9, the minus terminal 45 of the 18V device body, the upper side minus terminal 8, and the negative electrode of the upper side cell unit 4 is formed. The power supply circuit 3 generates the power supply voltage VDD through the parallel output voltage (18V) of the upper side cell unit 4 and the lower side cell unit 5, and supplies it to the control unit 2.

In the series connection state shown in FIG. 1 (C), a closed loop of the positive electrode of the lower side cell unit 5, the lower side plus terminal 7, the shorting bar 46 of the 36V device body, the upper side minus terminal 8, the negative electrode of the upper side cell unit 4, the positive electrode of the upper side cell unit 4, the diode D1, the power supply circuit 3, and the negative electrode the lower side cell unit 5 is formed. The closed loop is formed including the first circuit 10E and the second circuit 10F. The power supply circuit 3 generates the power supply voltage VDD through the series output voltage (36V) of the upper side cell unit 4 and the lower side cell unit 5, and supplies it to the control unit 2.

In this way, the battery pack 10 is configured to change a connection mode of the power supply circuit 3, the upper side cell unit 4, and the lower side cell unit 5 according to the connection state of the upper side cell unit 4 and the lower side cell unit 5. The connection state of the upper side cell unit 4 and the lower side cell unit 5 may be changed by connecting the battery pack 10 to the 18V device body or the 36V device body.

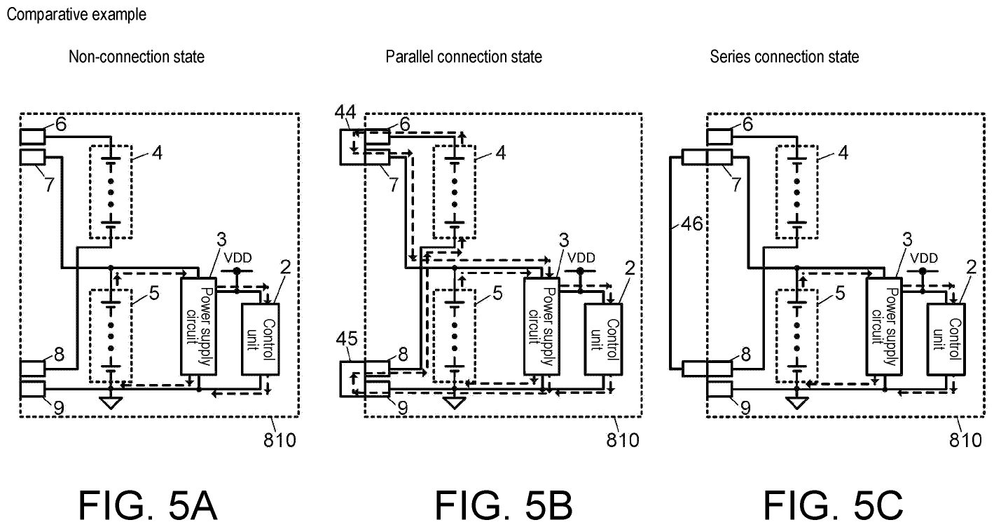

According to this embodiment, the positive electrode of the upper side cell unit 4 and the power supply circuit 3 are electrically connected via the first circuit 10E. The negative electrode of the lower side cell unit 5 and the power supply circuit 3 are electrically connected via the second circuit 10F. Thus, by connecting the battery pack 10 to the electric device body, the power supply circuit 3 is configured to supply the power supply voltage VDD to the control unit 2 through DC output voltages from the upper side cell unit 4 and the lower side cell unit 5. The power supply circuit 3 is configured to be electrically connected to the positive electrode of the upper side cell unit 4 and the negative electrode of the lower side cell unit 5 as the series connection state shown in FIG. 1 (C), and supply the power supply voltage VDD to the control unit 2 through the series output voltages of the upper side cell unit 4 and the lower side cell unit 5. Thus, compared with a configuration in which the power supply circuit 3 supplies the power supply voltage VDD to the control unit 2 only by the output voltage of the lower side cell unit 5 in the series connection state (refer to the comparative example to be described later in FIG. 5), it is possible to suppress the occurrence of an imbalance of voltages between the upper side cell unit 4 and the lower side cell unit 5 in the series connection state.

### (Embodiment 2)

FIGS. 2 (A) to (C) relate to a battery pack 10A according to embodiment 2 of the present invention. The battery pack 10A is formed by adding a diode D3 to the battery pack 10 of embodiment 1 shown in FIGS. 1 (A) to (C). The following description focuses on the differences from embodiment 1.

The anode of the diode D3 is connected to the negative electrode of the lower side cell unit 5 and the ground terminal of the power supply circuit 3. The cathode of the diode D3 is connected to the negative electrode of the upper side cell unit 4. A third circuit 10G connecting the power supply circuit 3 (the ground terminal of the power supply circuit 3) and the negative electrode of the upper side cell unit 4 is formed on a circuit board (not shown) of the battery pack.

In the cut-off state shown in FIG. 2 (A), in addition to the lower side closed loop as in the case of FIG. 1 (A), a closed loop of the positive electrode of the upper side cell unit 4, the diode D1, the power supply circuit 3, the diode D3, and the negative electrode of the upper side cell unit 4 is also formed. The closed loop includes the third circuit 10G and the first circuit 10E. The power supply circuit 3 generates the power supply voltage VDD through the parallel output voltage (18V) of the upper side cell unit 4 and the lower side cell unit 5, and supplies it to the control unit 2.

The flow of supplying power to the power supply circuit 3 in FIGS. 2 (B) and (C) is the same as the flow of supplying power to the power supply circuit 3 in FIGS. 1 (B) and (C).

According to this embodiment, the power supply circuit 3 is configured to be electrically connected to the positive electrode and negative electrode of both the upper side cell unit 4 and the lower side cell unit 5 in the cut-off state shown in FIG. 2 (A), and the power supply voltage VDD is supplied to the control unit 2 through the parallel output voltage of the upper side cell unit 4 and the lower side cell unit 5. Thus, compared with embodiment 1, it is possible to suppress the occurrence of an imbalance of voltages between the upper side cell unit 4 and the lower side cell unit 5 in the cut-off state.

### (Embodiment 3)

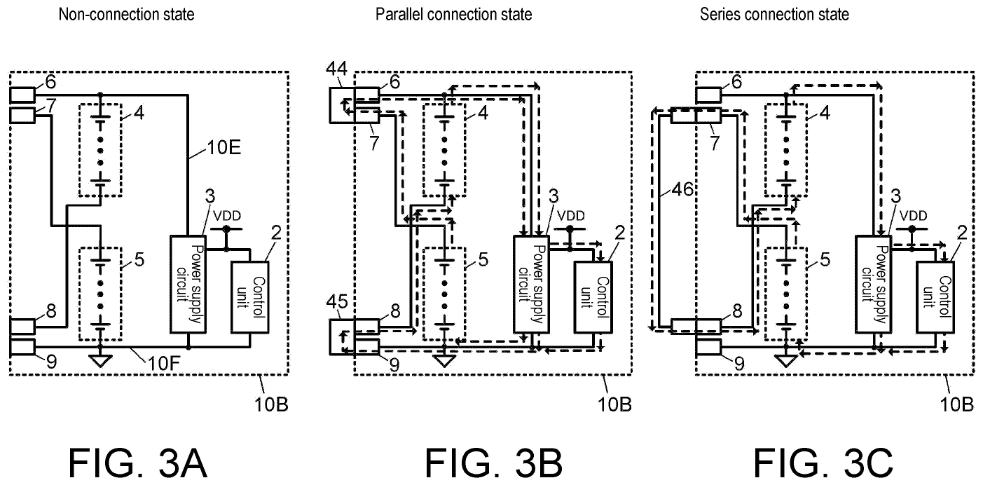

FIGS. 3 (A) to (C) relate to a battery pack 10B according to embodiment 3 of the present invention. In the battery pack 10B, the diode DI of the battery pack 10 in embodiment 1 shown in FIGS. 1 (A) to (C) is removed and replaced with a short circuit, and the diode D2 is removed and replaced with an open circuit. The following description focuses on the differences from embodiment 1.

In the cut-off state shown in FIG. 3 (A), since it lacks the diode D2 in FIG. 1 (A), a closed loop including the power supply circuit 3 is not formed. Thus, the power supply circuit 3 is not electrically connected to any one of the upper side cell unit 4 and the lower side cell unit 5, and does not generate the power supply voltage VDD. Thus, the control unit 2 is always stopped in the cut-off state. The first circuit 10E and the second circuit 10F are formed.

In the parallel connection state shown in FIG. 3 (B), a closed loop of the positive electrode of the lower side cell unit 5, the lower side plus terminal 7, the plus terminal 44 of the 18V device body, the upper side plus terminal 6, the power supply circuit 3, and the negative electrode of the lower side cell unit 5 is formed, and a closed loop of the positive electrode of the upper side cell unit 4, the power supply circuit 3, the lower side minus terminal 9, the minus terminal 45 of the 18V device body, the upper side minus terminal 8, and the negative electrode of the upper side cell unit 4. The power supply circuit 3 generates the power supply voltage VDD from the parallel output voltage (18V) of the upper side cell unit 4 and the lower side cell unit 5, and supplies it to the control unit 2.

The flow of supplying power to the power supply circuit 3 in FIG. 3 (C) is one with the diode D1 removed from the flow of supplying power to the power supply circuit 3 in FIG. 1 (C).

According to this embodiment, the power supply circuit 3 is configured not to be electrically connected to either the upper side cell unit 4 or the lower side cell unit 5 in the cut-off state shown in FIG. 3 (A), and does not generate the power supply voltage VDD. Thus, compared with embodiment 1, although it is not possible to display the remaining capacity in the cut-off state, it is possible to suppress the occurrence of an imbalance of voltages between the upper side cell unit 4 and the lower side cell unit 5 in the cut-off state. Since the first circuit 10E and the second circuit 10F are formed, by connecting the battery pack 10 to the electric device body, the power supply circuit 3 is configured to supply the power supply voltage VDD to the control unit 2 through DC output voltages from the upper side cell unit 4 and the lower side cell unit 5.

### (Embodiment 4)

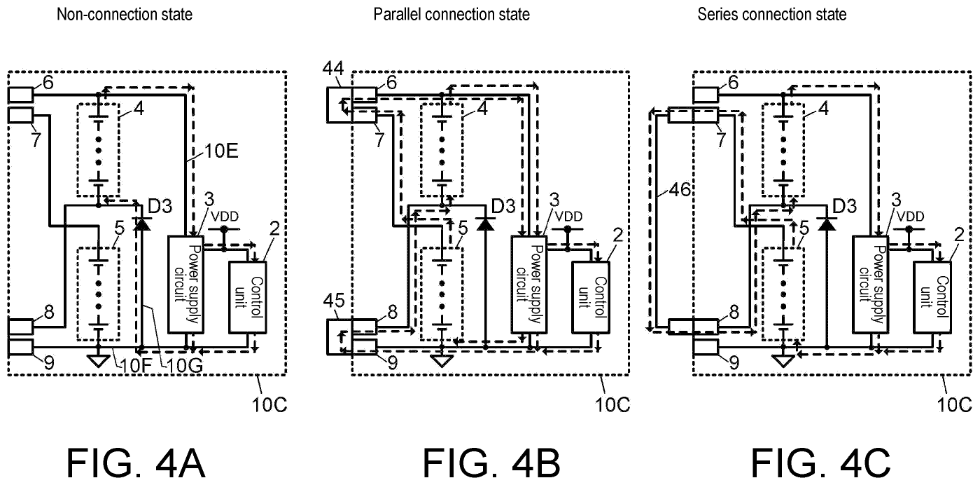

FIGS. 4 (A) to (C) relate to a battery pack 10C according to embodiment 4 of the present invention. The battery pack 10C is formed by adding the diode D3 to the battery pack 10B of embodiment 3 shown in FIGS. 3 (A) to (C). The following description focuses on the differences from embodiment 3.

The anode of the diode D3 is connected to the negative electrode of the lower side cell unit 5 and the ground terminal of the power supply circuit 3. The cathode of the diode D3 is connected to the negative electrode of the upper side cell unit 4. The third circuit 10G connecting the power supply circuit 3 (the ground terminal of the power supply circuit 3) and the negative electrode of the upper side cell unit 4 is formed on a circuit board (not shown) of the battery pack.

In the cut-off state shown in FIG. 4 (A), a closed loop of the positive electrode of the upper side cell unit 4, the power supply circuit 3, the diode D3, and the negative electrode of the upper side cell unit 4 is formed. The power supply circuit 3 generates the power supply voltage VDD through the output voltage (18V) of the upper side cell unit 4, and supplies it to the control unit 2. Since the positive electrode of the lower side cell unit 5 is opened, the output voltage of the lower side cell unit 5 is not involved in the generation of the power supply voltage VDD.

The flow of supplying power to the power supply circuit 3 in FIGS. 4 (B) and (C) is the same as the flow of supplying power to the power supply circuit 3 in FIGS. 3 (B) and (C).

In this embodiment, in relation to embodiment 1, the power supply source to the power supply circuit 3 in the cut-off state is switched from the lower side cell unit 5 to the upper side cell unit 4. Like embodiment 1, this embodiment is capable of suppressing the occurrence of an imbalance of voltages between the upper side cell unit 4 and the lower side cell unit 5 in the series connection state.

### (Comparative Example)

FIGS. 5 (A) to (C) relate to a battery pack 810 according to a comparative example. In the battery pack 810, the diode D1 of the battery pack 10 in embodiment 1 shown in FIGS. 1 (A) to (C) is removed and replaced with an open circuit, and the diode D2 is removed and replaced with a short circuit. The following description focuses on the differences from embodiment 1.

The flow of supplying power to the power supply circuit 3 in FIG. 5 (A) is one that lacks the diode D2 from the flow of supplying power to the power supply circuit 3 in FIG. 1 (A). The first circuit 10E is not formed.

In the parallel connection state shown in FIG. 5 (B), in addition to the closed loop as shown in FIG. 5 (A), a closed loop of the positive electrode of the upper side cell unit 4, the upper side plus terminal 6, the plus terminal 44 of the 18V device body, the lower side plus terminal 7, the power supply circuit 3, the lower side minus terminal 9, the minus terminal 45 of the 18V device body, the upper side minus terminal 8, and the negative electrode of the upper side cell unit 4 is formed. The power supply circuit 3 generates the power supply voltage VDD from the parallel output voltage (18V) of the upper side cell unit 4 and the lower side cell unit 5, and supplies it to the control unit 2.

In the series connection state shown in FIG. 5 (C), there is the same closed loop as in FIG. 5 (A). On the other hand, since the positive electrode of the upper side cell unit 4 is opened, the output voltage of the upper side cell unit 4 is not involved in the generation of the power supply voltage VDD.

In this comparative example, in the series connection state shown in FIG. 5 (C), the power supply circuit 3 generates the power supply voltage VDD only from the output voltage of the lower side cell unit 5, so an imbalance of voltages between the upper side cell unit 4 and the lower side cell unit 5 is easy to occur in the series connection state. Embodiments 1 to 4 described above appropriately solve the problems of this comparative example as configurations in which the power supply circuit 3 generates the power supply voltage VDD from the output voltages of both the upper side cell unit 4 and the lower side cell unit 5 in the series connection state.

### (Embodiment 5)

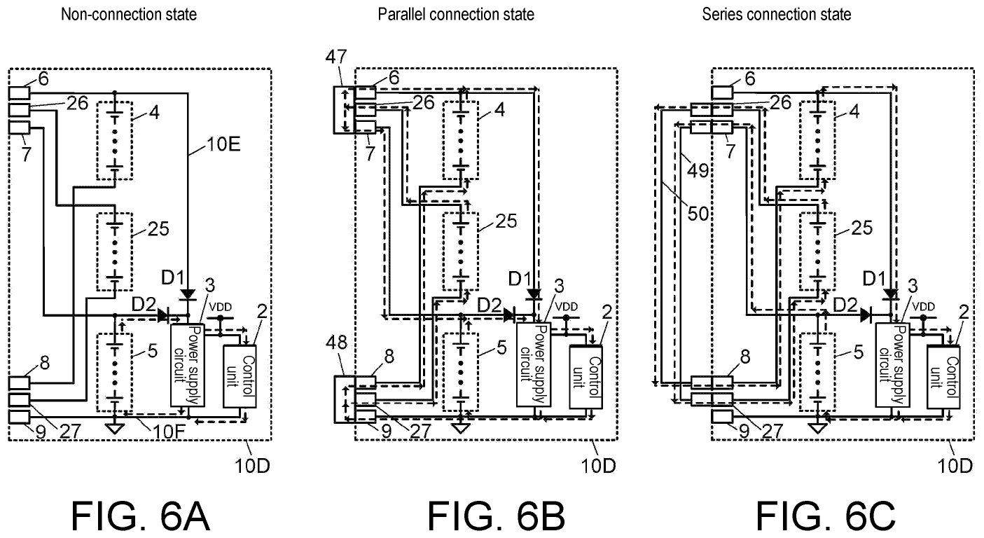

FIGS. 6 (A) to (C) relate to a battery pack 10D according to embodiment 5 of the present invention. The battery pack 10D is formed by adding an intermediate cell unit 25 as a third cell unit, an intermediate plus terminal 26 as a third plus terminal, and an intermediate minus terminal 27 as a third minus terminal to the battery pack 10 of embodiment 1 shown in FIGS. 1 (A) to (C). The following description focuses on the differences from embodiment 1.

The intermediate cell unit 25 has multiple battery cells connected in series with each other. Here, as an example, a description will be given assuming that the rated output voltage of the intermediate cell unit 25 is 18V. The intermediate plus terminal 26 and the intermediate minus terminal 27 are terminals for connection with electric device body. The intermediate plus terminal 26 is connected to the positive electrode of the intermediate cell unit 25. The intermediate minus terminal 27 is connected to the negative electrode of the intermediate cell unit

The cut-off state shown in FIG. 6 (A) is a non-connection state in which the battery pack 10D is not connected to the electric device body, and a state in which the upper side cell unit 4, the intermediate cell unit 25, and the lower side cell unit 5 are separated from each other.

The parallel connection state shown in FIG. 6 (B) is a state in which the battery pack 10D is connected to the 18V device body. In the parallel connection state, the upper side plus terminal 6, the intermediate plus terminal 26, and the lower side plus terminal 7 are connected (short-circuited) with each other through a plus terminal 47 of the 18V device body, and the upper side minus terminal 8, the intermediate minus terminal 27, and the lower side minus terminal 9 are connected (short-circuited) with each other through a minus terminal 48 of the 18V device body. In the parallel connection state, the voltage between the plus terminal 47 and the minus terminal 48, namely the output voltage of the battery pack 10D, is 18V.

The series connection state shown in FIG. 6 (C) is a state in which the battery pack 10D is connected to an electric device body having a rated input voltage of 54V (hereinafter also referred to as “54V device body”). In the series connection state, the lower side plus terminal 7 and the intermediate minus terminal 27 are connected (short-circuited) with each other through a shorting bar 49 of the 54V device body, and the intermediate plus terminal 26 and the upper side minus terminal 8 are connected (short-circuited) with each other through a shorting bar 50 of the 54V device body. In the series connection state, the voltage between the upper side plus terminal 6 and the lower side minus terminal 9, namely the output voltage of the battery pack 10D, is 54V.

The flow of supplying power to the power supply circuit 3 in FIG. 6 (A) is the same as the flow of supplying power to the power supply circuit 3 in FIG. 1 (A). As in FIG. 1 (A), the first circuit 10E and the second circuit 10F are formed.

In the parallel connection state shown in FIG. 6 (B), in addition to the lower side closed loop as in the case of FIG. 1 (A), a closed loop of the positive electrode of the intermediate cell unit 25, the intermediate plus terminal 26, the plus terminal 47 of the 18V device body, the upper side plus terminal 6, the diode D1, the power supply circuit 3, the lower side minus terminal 9, the minus terminal 48 of the 18V device body, the intermediate minus terminal 27, and the negative electrode of the intermediate cell unit 25 is formed. Moreover, a closed loop of the positive electrode of the upper side cell unit 4, the diode D1, the power supply circuit 3, the lower side minus terminal 9, the minus terminal 48 of the 18V device body, the upper side minus terminal 8, and the negative electrode of the upper side cell unit 4 is formed. The power supply circuit 3 generates the power supply voltage VDD by the parallel output voltage (18V) of the upper side cell unit 4, the intermediate cell unit 25, and the lower side cell unit 5, and supplies it to the control unit 2.

In the series connection state shown in FIG. 6 (C), a closed loop of the positive electrode of the lower side cell unit 5, the lower side plus terminal 7, the shorting bar 49 of 54V device body, the intermediate minus terminal 27, the negative electrode of the intermediate cell unit 25, the positive electrode of the intermediate cell unit 25, the intermediate plus terminal 26, the shorting bar 50 of 54V device body, the upper side minus terminal 8, the negative electrode of the upper side cell unit 4, the positive electrode of the upper side cell unit 4, the diode D1, the power supply circuit 3, and the negative electrode of the lower side cell unit 5 is formed. The power supply circuit 3 generates the power supply voltage VDD by the series output voltage (54V) of the upper side cell unit 4, the intermediate cell unit 25, and the lower side cell unit 5, and supplies it to the control unit 2.

According to this embodiment, the power supply circuit 3 is configured to be electrically connected to the positive electrode of the upper side cell unit 4 on the highest voltage side and the negative electrode of the lower side cell unit 5 on the lowest voltage side, in the series connection state shown in FIG. 6 (C), and supply the power supply voltage VDD to the control unit 2 by the series output voltages of the upper side cell unit 4, the intermediate cell unit 25, and the lower side cell unit 5. Thus, it is possible to suppress the occurrence of an imbalance of voltages in the upper side cell unit 4, the intermediate cell unit 25, and the lower side cell unit 5 in the series connection state.

### (Embodiment 6)

This embodiment relates to electric devices 1, 1A, and 1B. FIG. 7 is a circuit block diagram of the electric device 1 that connects the battery pack 10 of embodiment 1 shown in FIGS. 1 (A) to (C) and an electric device body 30 having a rated input voltage of 36V (hereinafter referred to as “36V device body 30”) to each other. The battery pack 10 will be described focusing on components not shown in FIGS. 1 (A) to (C).

The upper + terminal of the battery pack 10 corresponds to the upper side plus terminal 6 in FIG. 1. The lower + terminal corresponds to the lower side plus terminal 7 in FIG. 1. The upper − terminal corresponds to the upper side minus terminal 8 in FIG. 1. The lower − terminal corresponds to the lower side minus terminal 9 in FIG. 1.

The upper + terminal of the battery pack 10 is connected to the + terminal of the 36V device body 30. The lower + terminal of the battery pack 10 is connected to one end of the shorting bar 46 of the 36V device body 30. The upper − terminal of the battery pack 10 is connected to the other end of the shorting bar 46. The lower − terminal of the battery pack 10 is connected to the − terminal of the 36V device body 30. LD terminals of the battery pack 10 and the 36V device body 30 are connected to each other.

The battery pack 10 includes a display unit 11, an operation switch 12, an upper + terminal voltage detection circuit 13, an upper side cell unit protection IC 14, a lower side cell unit protection IC 15, a current detection circuit 17, a cell temperature detection unit 18, cell voltage information output units 19 and 20, fuses 21 and 22, a discharge prohibition signal output unit 23, a charge prohibition signal output unit 24, and a resistor R1.

The fuse 21 and the upper side cell unit 4 are connected in series between the upper + terminal and the upper − terminal. The fuse 22, the lower side cell unit 5, and the resistor R1 are connected in series between the lower + terminal and the lower − terminal.

The display unit 11 displays the remaining capacity of the battery pack 10 and the presence or absence of an abnormality (failure). The operation switch 12 is a remaining capacity display switch, and instructs the control unit 2 to start displaying the remaining capacity to the display unit 11 according to the user's operation. The upper + terminal voltage detection circuit 13 detects the voltage of the upper + terminal and sends it to the control unit 2.

The upper side cell unit protection IC 14 acquires information required for protecting the upper side cell unit 4, such as the voltage of each cell of the upper side cell unit 4. The cell voltage information output unit 19 sends information such as cell voltage information corresponding to the signal from the upper side cell unit protection IC 14 to the control unit 2. The lower side cell unit protection IC 15 acquires information required for protecting the lower side cell unit 5, such as the voltage of each cell of the lower side cell unit 5. The cell voltage information output unit 20 sends information such as cell voltage information corresponding to the signal from the lower side cell unit protection IC 15 to the control unit 2.

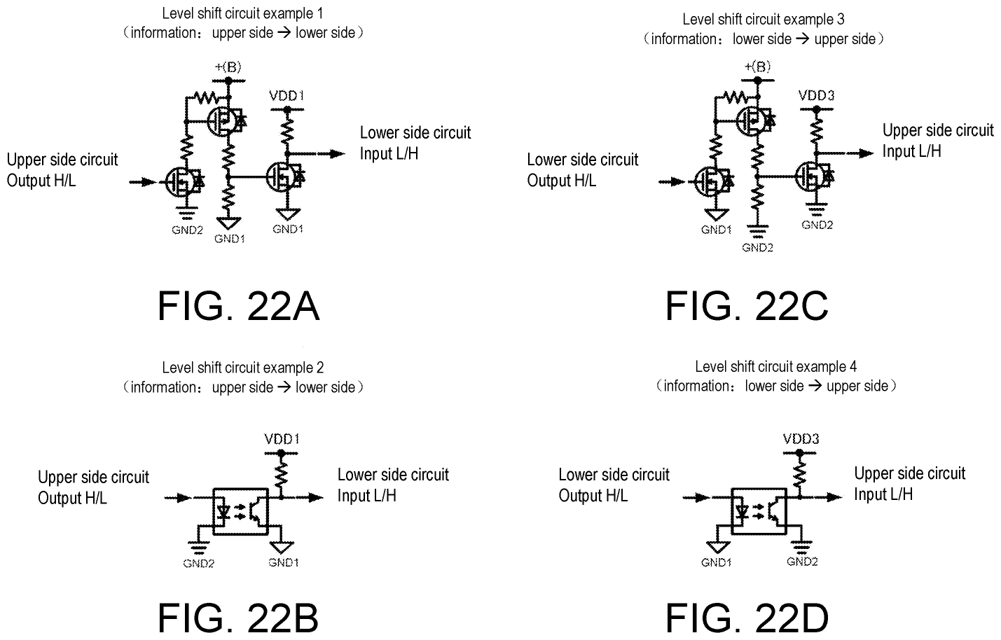

The upper side cell unit protection IC 14 operates with the potential of the negative electrode of the upper side cell unit 4 as the ground potential (operates based on GND2). The control unit 2, the power supply circuit 3, and the lower side cell unit protection IC 15 operate the potential of the negative electrode of the lower side cell unit 5 as the ground potential (operate based on GND1). Thus, the cell voltage information output unit 19 includes a level shift circuit for coping with the difference in ground potential between the upper side cell unit protection IC 14 and the control unit 2. As the level shift circuit, for example, a circuit shown in FIG. 22 (A) or (B) to be described later may be used.

The current detection circuit 17 detects the current of the lower side cell unit 5 by the voltage of the resistor R1 and sends it to the control unit 2. The cell temperature detection portion 18 detects the temperatures of the upper side cell unit 4 and the lower side cell unit 5 based on the output signals of temperature sensors such as thermistors (not shown) provided near the upper side cell unit 4 and the lower side cell unit 5, and sends them to the control unit 2. The discharge prohibition signal output unit 23 outputs the discharge prohibition signal to the LD terminal under the control of the control unit 2. The charge prohibition signal output unit 24 outputs the charge prohibition signal to a LS terminal according to the control of the control unit 2. The control unit 2 controls the display of the display unit 11, the protection when an abnormality is detected (output of the discharge prohibition signal and the charge prohibition signal), and the like.

The 36V device body 30 includes a display unit 31, an operation unit 32, a control unit 33, a power supply circuit 34, a battery voltage detection circuit 35, a switch state detection circuit 36, a current detection circuit 37, a motor 40b a switching element 41 such as a FET, a trigger switch 42 as a main switch, the shorting bar 46, and a resistor R3.

The trigger switch 42, the motor 40, the switching element 41, and the resistor R3 are connected in series between the + terminal and the − terminal. The shorting bar 46 short-circuits between the lower + terminal and the upper − terminal of the battery pack 10. The power supply circuit 34 converts the output voltage of the battery pack 10 input via the + terminal into a power supply voltage VDD2 (for example, 5V) of the control unit 33 and the like, and supplies it to the control unit 33 and the like.

The battery voltage detection circuit 35 detects the voltage at the + terminal and sends it to the control unit 33. The switch state detection circuit 36 detects the ON/OFF of the trigger switch 42 and sends it to the control unit 33. The current detection circuit 37 detects the current of the motor 40 based on the voltage of the resistor R3 and sends it to the control unit 33.

The display unit 31 displays the operation mode of the electric device body 30 or the presence or absence of abnormality (failure). The operation unit 32 is a display switch for the user to instruct the display unit 31 to start displaying to the control unit 33.

The control unit 33 controls the display of the display unit 31 according to the operation unit 32. The control unit 33 is a controller that controls the start and stop of the motor 40 according to the operation of the trigger switch 42. The motor 40 is an example of a driving part (output unit) driven by the power of the battery pack 10. Upon receiving the discharge prohibition signal from the control unit 2 via the LD terminal, the control unit 33 turns off the switching element 41 and stops the motor 40.

In the electric device 1, since the battery pack 10 supplies a power supply voltage VDD1 (corresponding to VDD in FIGS. 1 (A) to (C)) to the control unit 2 by the series output voltages of the upper side cell unit 4 and the lower side cell unit 5, the occurrence of an imbalance of voltages between the upper side cell unit 4 and the lower side cell unit 5 can be suppressed compared to a configuration in which the power supply voltage VDDI is supplied to the control unit 2 only by the output voltage of the lower side cell unit 5.

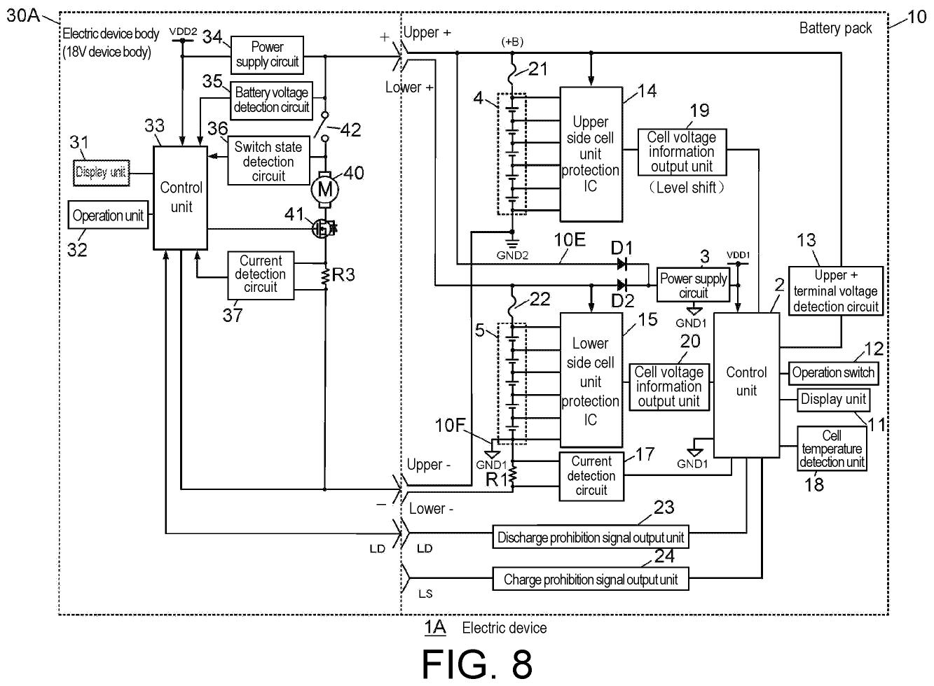

FIG. 8 is a circuit block diagram of the electric device 1A that connects the battery pack 10 of embodiment 1 shown in FIGS. 1 (A) to (C) and an electric device body 30A having a rated input voltage of 18V (hereinafter referred to as “18V device body 30A”) to each other.

The + terminal of the 18V device body 30A corresponds to the plus terminal 44 of FIG. 1 (B). The − terminal of the 18V device body 30A corresponds to the minus terminal 45 in FIG. 1 (B). The 18V device body 30A differs from the 36V device body 30 shown in FIG. 7 in that it lacks the shorting bar 46 of the 36V device body 30; the plus terminal 44 short-circuits between the upper + terminal and the lower + terminal of the battery pack 10; the minus terminal 45 short-circuits between the upper − terminal and lower − terminal of the battery pack 10; and it operates by receiving the 18V supply from the battery pack 10. They are the same in other respects.

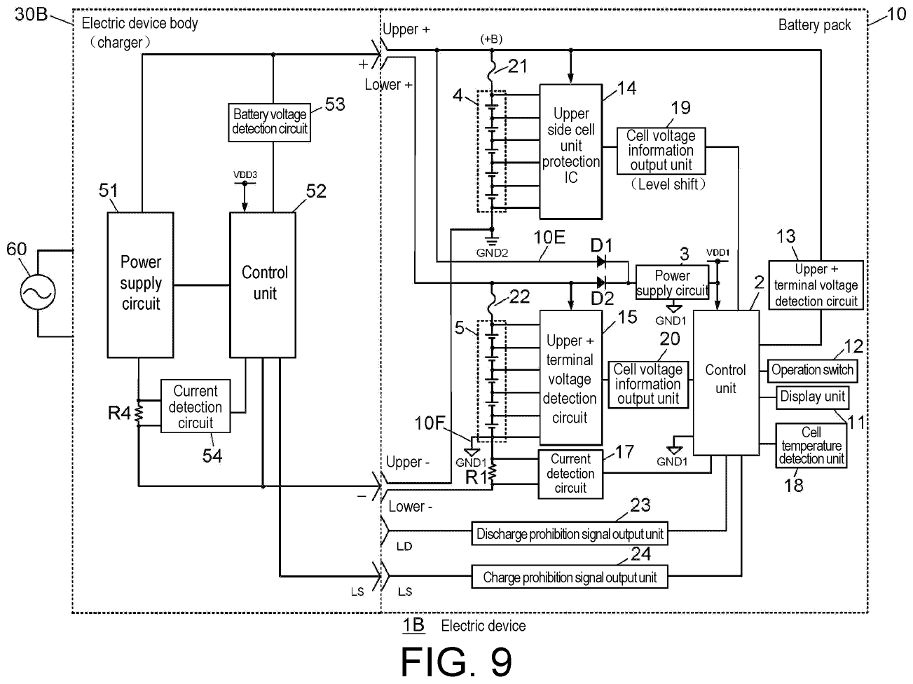

FIG. 9 is a circuit block diagram of the electric device 1B that connects the battery pack 10 of embodiment 1 shown in FIGS. 1 (A) to (C) and an electric device body 30B to each other. The electric device body 30B is a charger that may charge the battery pack 10. The + terminal of the electric device body 30B short-circuits between the upper + terminal and the lower + terminal of the battery pack 10. The − terminal of the electric device body 30B short-circuits between the upper − terminal and the lower − terminal of the battery pack 10. The LS terminals of the electric device body 30B and the battery pack 10 are connected to each other.

The electric device body 30B includes a power supply circuit 51 that supplies charging power to the battery pack 10 based on the supplied power from an external AC power supply 60, a control unit 52 that controls the power supply circuit 51, a battery voltage detection circuit 53 that detects the output voltage of the battery pack 10, a resistor R4 provided in the current path of the power supply circuit 51, and a current detection circuit 54 that detects the charging current based on the voltage of the resistor R4 and sends it to the control unit 52. Upon receiving the charge prohibition signal from the battery pack 10 via the LS terminal, the charging current detection control unit 52 stops the supply of charging power by the power supply circuit 51.

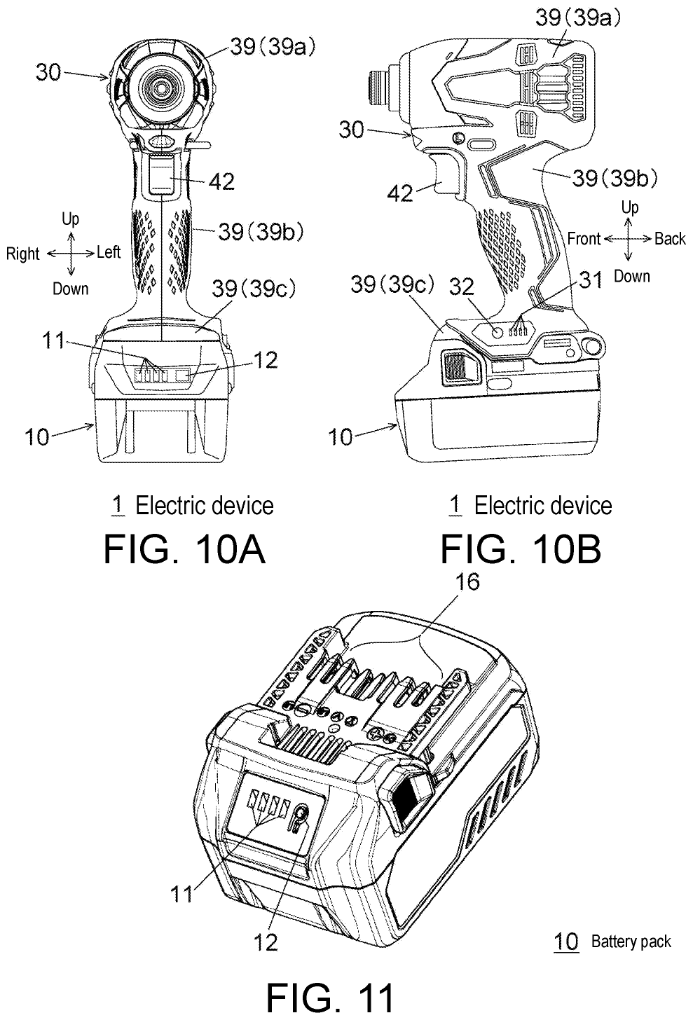

FIGS. 10 (A) and (B) show the appearance of the electric device 1 shown in FIG. 7. FIG. 11 is a perspective view of the battery pack 10. The front and back, up and down, and left and right directions orthogonal to each other of the electric device 1 are defined by FIGS. 10 (A) and (B). The electric device 1 has the battery pack 10 and the electric device body 30. The electric device body 30 is an impact driver. The electric device body 30 has a housing 39. The housing 39 includes a body part 39a, a handle part 39b, and a battery pack mounting part 39c.

The body part 39a is a cylindrical part whose central axis is parallel to the front-back direction, and accommodates the motor 40 shown in FIG. 7, a rotary impact mechanism (not shown), and the like. The handle part 39b extend downward from the middle portion of the body part 39a. The electric device body 30 has the trigger switch 42 at the upper end of the handle part 39b. The trigger switch 42 is operated by a user to indicate the start and stop of the motor 40.

The battery pack mounting part 39c is provided at the lower end of the handle part 39b. The battery pack 10 may be detachably attached to the battery pack mounting part 39c. The battery pack 10 has the display unit 11 and the operation switch 12 at the upper part of the front surface. As shown in FIG. 11, the battery pack 10 has a terminal part 16 on the upper surface for electrical connection with the electric device body 30. A control board on which the control unit 33 and the power supply circuit 34 shown in FIG. 7 are mounted is provided inside the battery pack mounting part 39c. On the left side of the battery pack mounting part 39c, the display unit 31 and the operation unit 32 are provided.

In FIGS. 7 to 10, the electric devices that connect the battery pack 10 according to embodiment 1 and the electric device body is described, but the electric device may also be similarly configured by connecting the battery pack other than embodiment 1 and the electric device body.

### (Embodiment 7)

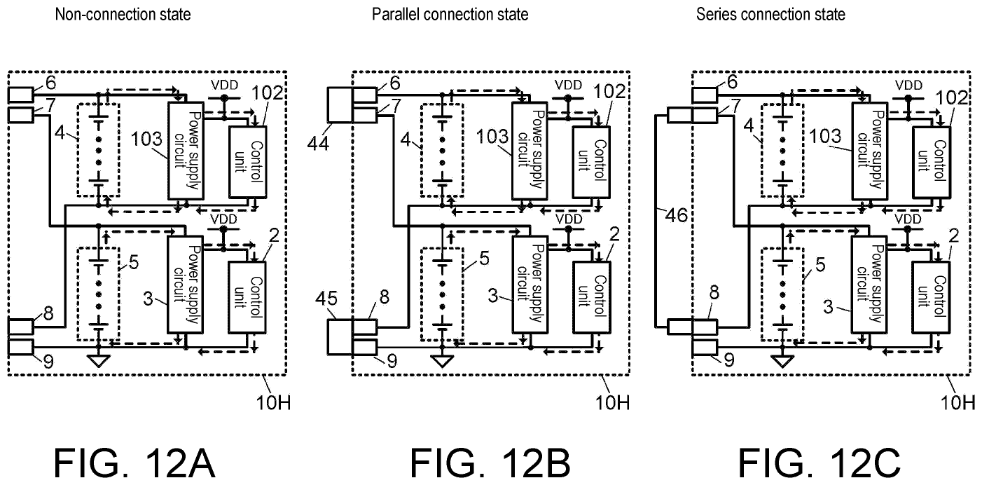

FIGS. 12 (A) to (C) relate to a battery pack 10H according to embodiment 7 of the present invention. In the battery pack 10H, the diode D1 of the battery pack 10 according to embodiment 1 shown in FIGS. 1 (A) to (C) is removed and replaced with an open circuit, and the diode D2 is removed and replaced with a short circuit, and a control unit 102 and a power supply circuit 103 are added. The following description focuses on the differences from embodiment 1.

The power supply circuit 103 converts the output voltage of the upper side cell unit 4 into the power supply voltage of the control unit 102, and supplies it to the control unit 102. The control unit 102 performs the overall operation control of the battery pack 10H in parallel with the control unit 2.

In any of the non-connection state, parallel connection state, and series connection state shown in FIGS. 12 (A) to (C), the power supply circuit 3 generates the power supply voltage of the control unit 2 by the output voltage of the lower side cell unit 5, and the power supply circuit 103 generates the power supply voltage of the control unit 102 by the output voltage of the upper side cell unit 4.

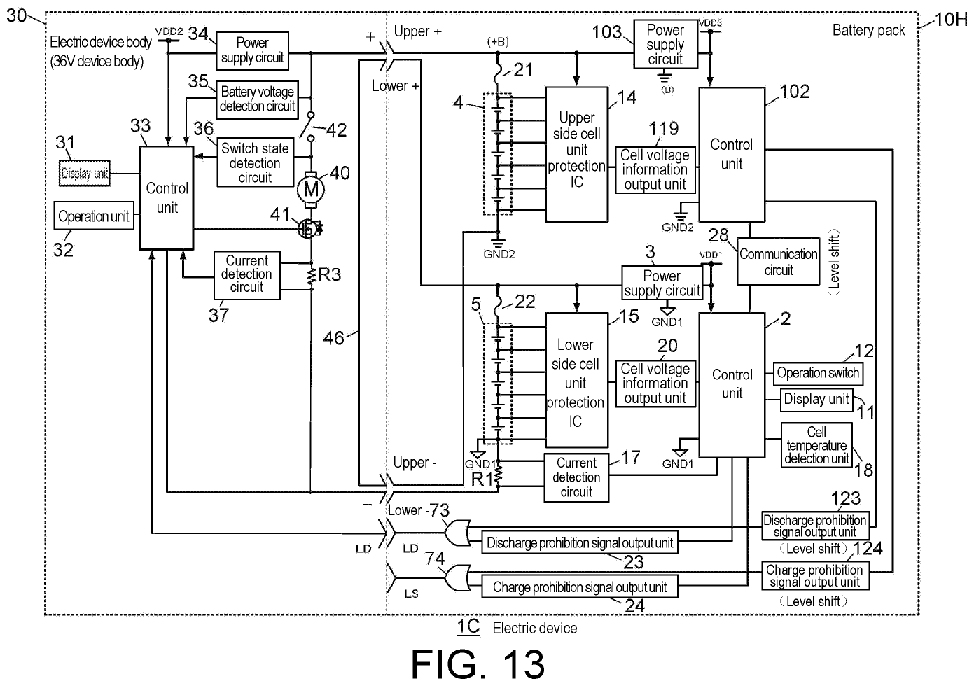

FIG. 13 is a circuit block diagram of an electric device 1C that connects the battery pack 10H and the electric device body 30 to each other. The following description focuses on the differences from FIG. 7.

A cell voltage information output unit 119 sends information such as cell voltage information corresponding to the signal from the upper side cell unit protection IC 14 to the control unit 102. The control unit 102 operates with the potential of the negative electrode of the upper side cell unit 4 as the ground potential (operates based on GND2). Thus, there is no need to provide a level shift circuit in the cell voltage information output unit 119.

A communication circuit 28 is a communication path through which the control units 2 and 102 communicate with each other, and is, for example, a circuit for serial communication. Corresponding to the difference in ground potentials between the control units 2 and 102, the communication circuit 28 includes a level shift circuit. As a level shift circuit provided in a signal transmission path from the control unit 2 to the control unit 102, for example, a circuit shown in FIG. 22 (A) or (B) to be described later may be used. As a level shift circuit provided in a signal transmission path from the control unit 102 to the control unit 2, for example, a circuit shown in FIG. 22 (C) or (D) to be described later may be used.

A discharge prohibition signal output unit 123 outputs the discharge prohibition signal to the LD terminal according to the control of the control unit 102. A charge prohibition signal output unit 124 outputs the charge prohibition signal to the LS terminal according to the control of the control unit 102.

An OR gate 73 outputs the OR signals of the discharge prohibition signal output units 23 and 123 to the LD terminal. Thus, when at least one of the control units 2 and 102 performs control to output the discharge prohibition signal (making the discharge prohibition signal at a high level), the discharge prohibition signal is output to the LD terminal (the voltage of the LD terminal is at a high level).

An OR gate 74 outputs the OR signal of the charge prohibition signal output units 24 and 124 to the LS terminal. Thus, when at least one of the control units 2 and 102 performs control to output the charge prohibition signal (making the charge prohibition signal at a high level), the charge prohibition signal is output to the LS terminal (the voltage of the LS terminal is at a high level).

The OR gates 73 and 74 operate with the potential of the negative electrode of the lower side cell unit 5 as the ground potential (operates based on GND1). Thus, corresponding to the difference in ground potentials between the control unit 102 and the OR gates 73 and 74, the discharge prohibition signal output unit 123 and the charge prohibition signal output unit 124 include level shift circuits. As the level shift circuit, for example, the circuit shown in FIG. 22 (A) or (B) to be described later may be used.

The control unit 2 may control the remaining capacity display of the display unit 11 based on the voltage of the lower side cell unit 5 that supplies power to itself, regardless of the voltage of the upper side cell unit 4. The control unit 2 may control the remaining capacity display of the display unit 11 based on the voltage of one of the upper side cell unit 4 and the lower side cell unit 5, which has a small voltage, without depending on the voltage of the other.

According to this embodiment, since the battery pack 10H has the control unit 102 with respect to the upper side cell unit 4, has the control unit 2 with respect to the lower side cell unit 5, and has the power supply circuits 3 and 103 for supplying the power supply voltages to the control units 2 and 102, respectively, it is possible to suppress the occurrence of an imbalance of voltages between the upper side cell unit 4 and the lower side cell unit 5. Further, by providing a level shift circuit that corresponds to differences in ground potential, it is possible to suitably handle the existence of two kinds of ground potentials. Further, even if one of the upper side cell unit 4 and the lower side cell unit 5 fails, one of the power supply circuits 3 and 103 fails, or one of the control units 2 and 102 fails, the control can be maintained. Thus, reliability will not be impaired.

### (Embodiment 8)

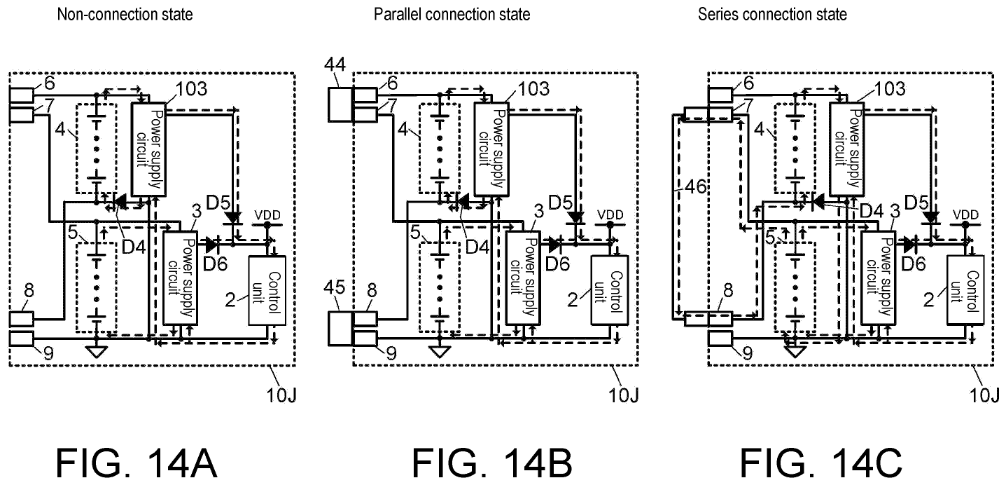

FIGS. 14 (A) to (C) relate to a battery pack 10J according to embodiment 8 of the present invention. In the battery pack 10J, the control unit 102 of the battery pack 10H in embodiment 7 shown in FIGS. 12 (A) to (C) is removed, and diodes D4 to D6 for preventing backflow are added. The following description focuses on the differences from embodiment 7.

The anode of the diode D4 is connected to the negative electrode of the lower side cell unit 5 and the ground terminals of the power supply circuits 3 and 103. The cathode of the diode D4 is connected to the negative electrode of the upper side cell unit 4. The anode of the diode D5 is connected to the output terminal of the power supply circuit 103. The cathode of the diode D5 is connected to the power supply input terminal of the control unit 2. The anode of the diode D6 is connected to the output terminal of the power supply circuit 3. The cathode of the diode D6 is connected to the power supply input terminal of the control unit 2.

In the non-connection state and the parallel connection state shown in FIGS. 14 (A) and (B) respectively, the power supply circuit 3 generates the power supply voltage of the control unit 2 by the output voltage of the lower side cell unit 5, and the power supply circuit 103 generates the power supply voltage of the control unit 2 by the output voltage of the upper side cell unit 4. In the series connection state shown in FIG. 14 (C), the power supply circuit 3 generates the power supply voltage of the control unit 2 by the output voltage of the lower side cell unit 5, and the power supply circuit 103 generates the power supply voltage of the control unit 2 by the series combined output voltage of the upper side cell unit 4 and the lower side cell unit 5.

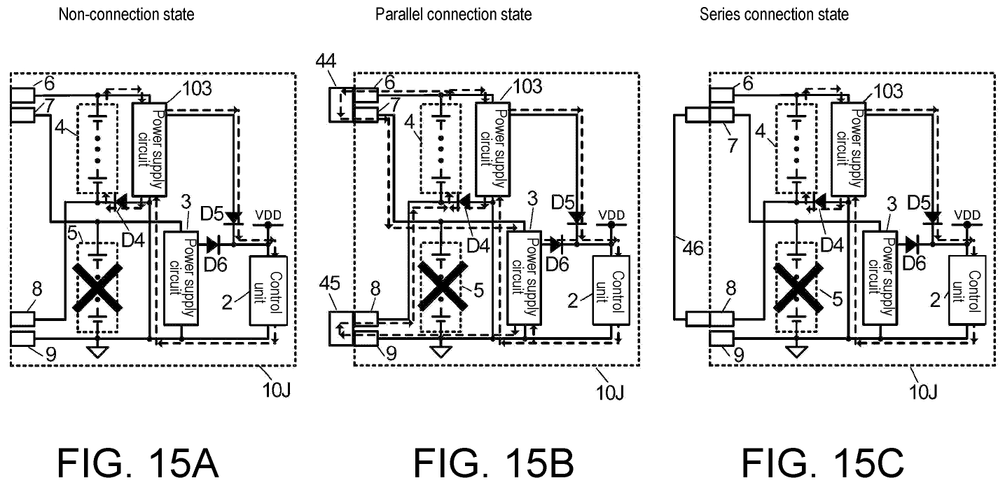

FIGS. 15 (A) to (C) relate to the battery pack 10J when the lower side cell unit 5 fails and becomes open (high impedance state). In the non-connection state and the series connection state shown in FIGS. 15 (A) and (C) respectively, the power supply circuit 3 cannot be driven because there is no power supply source, but the power supply circuit 103 generates the power supply voltage of the control unit 2 by the output voltage of the upper side cell unit 4, and the control unit 2 operates. In the parallel connection state shown in FIG. 15 (B), both the power supply circuits 3 and 103 generate the power supply voltage of the control unit 2 by the output voltage of the upper side cell unit 4, and the control unit 2 operates. Thus, even if the lower side cell unit 5 fails, the supply of power from one of the power supply circuits 3 and 103 to the control unit 2 may be continued, so reliability will not be impaired.

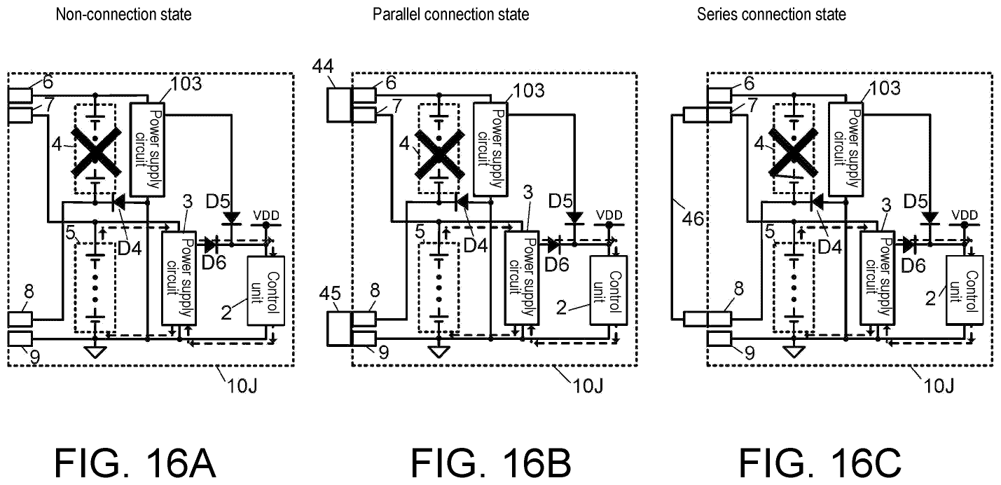

FIGS. 16 (A) to (C) relate to the battery pack 10J when the upper side cell unit 4 fails and becomes open (incapable of power supply output). In the non-connection state and the series connection state shown in FIGS. 16 (A) and (C) respectively, the power supply circuit 103 cannot be driven because there is no power supply source, but the power supply circuit 3 generates the power supply voltage of the control unit 2 by the output voltage of the lower side cell unit 5, and the control unit 2 operates. In the parallel connection state shown in FIG. 16 (B), both the power supply circuits 3 and 103 generate the power supply voltage of the control unit 2 by the output voltage of the lower side cell unit 5, and the control unit 2 operates. Moreover, actually, of the power supply circuits 3 and 103, the one with a larger power supply output voltage supplies power to the control unit 2. Thus, even if the upper side cell unit 4 fails, the supply of power from one of the power supply circuits 3 and 103 to the control unit 2 may be continued, so the reliability will not be impaired.

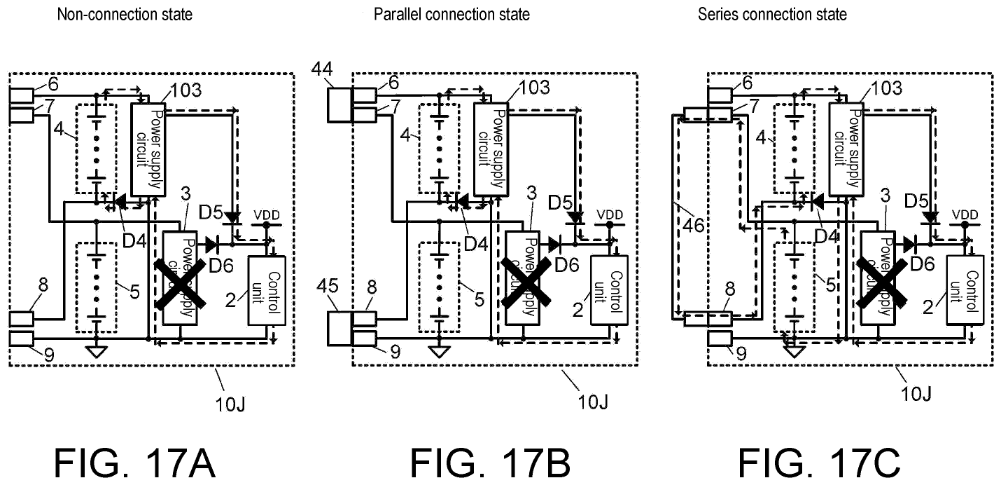

FIGS. 17 (A) to (C) relate to the battery pack 10J when the power supply circuit 3 fails and becomes open. In the non-connection state shown in FIG. 17 (A), the power supply circuit 103 generates the power supply voltage of the control unit 2 by the output voltage of the upper side cell unit 4, and the control unit 2 operates. In the parallel connection state shown in FIG. 17 (B), the power supply circuit 103 generates the power supply voltage of the control unit 2 by the parallel combined output voltages of the upper side cell unit 4 and the lower side cell unit 5, and the control unit 2 operates. In the series connection state shown in FIG. 17 (C), the power supply circuit 103 generates the power supply voltage of the control unit 2 by the series combined output voltage of the upper side cell unit 4 and the lower side cell unit 5, and the control unit 2 operates. Thus, even if the power supply circuit 3 fails, the supply of power to the control unit 2 may be continued by the power supply circuit 103, so the reliability will not be impaired.

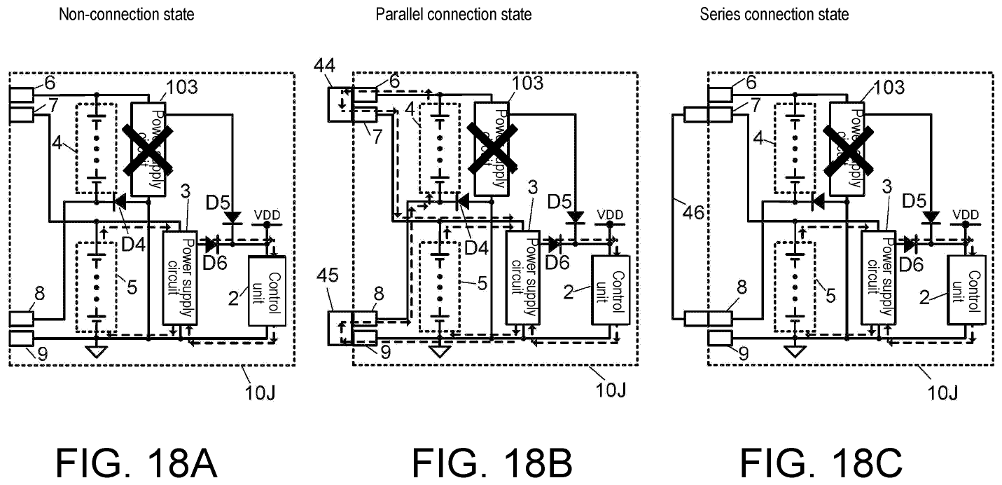

FIGS. 18 (A) to (C) relate to the battery pack 10J when the power supply circuit 103 fails and becomes open. In the non-connection state and the series connection state shown in FIGS. 18 (A) and (C) respectively, the power supply circuit 3 generates the power supply voltage of the control unit 2 by the output voltage of the lower side cell unit 5, and the control unit 2 operates. In the parallel connection state in FIG. 18 (B), the power supply circuit 3 generates the power supply voltage of the control unit 2 by the parallel combined output voltages of the upper side cell unit 4 and the lower side cell unit 5, and the control unit 2 operates. Thus, even if the power supply circuit 103 fails, the supply of power to the control unit 2 may be continued by the power supply circuit 3, so the reliability will not be impaired.

In any of FIGS. 15 (A) to (C), 16 (A) to (C), 17 (A) to (C), and 18 (A) to (C), the control unit 2 sends a discharge prohibition signal and a charge prohibition signal to report an abnormality to the electric device body.

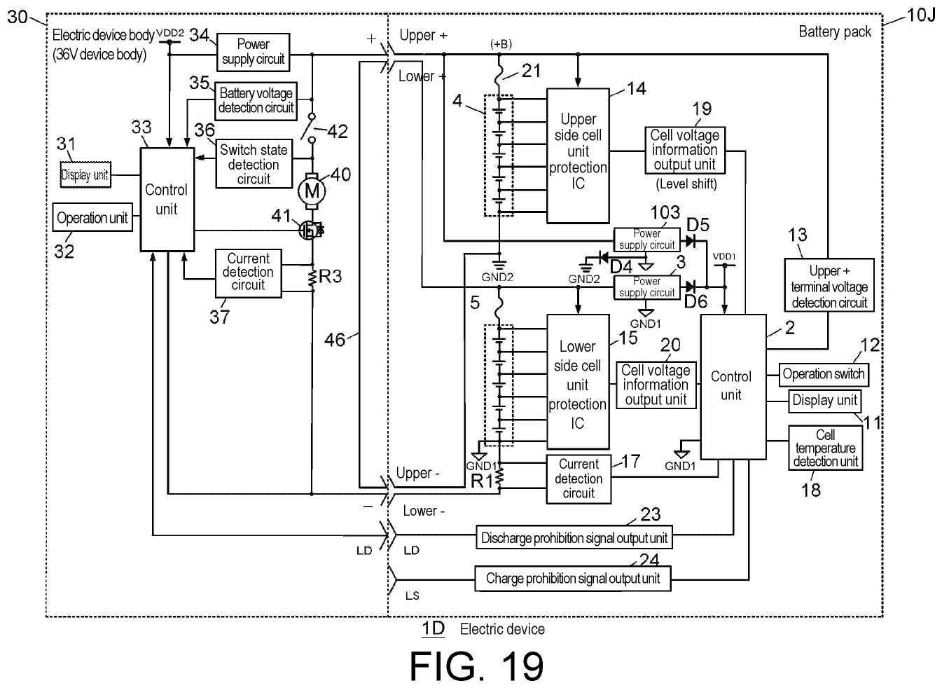

FIG. 19 is a circuit block diagram of an electric device 1D that connects the battery pack 10J and the electric device body 30 to each other. In relation to FIG. 13, in FIG. 19, it lacks the discharge prohibition signal output unit 123, the charge prohibition signal output unit 124, and the OR gates 73 and 74, corresponding to the lacking of the control unit 102. Moreover, the cell voltage information output unit 119 in FIG. 13 is replaced with the cell voltage information output unit 19 including a level shift circuit in FIG. 19 (the same as in FIG. 7).

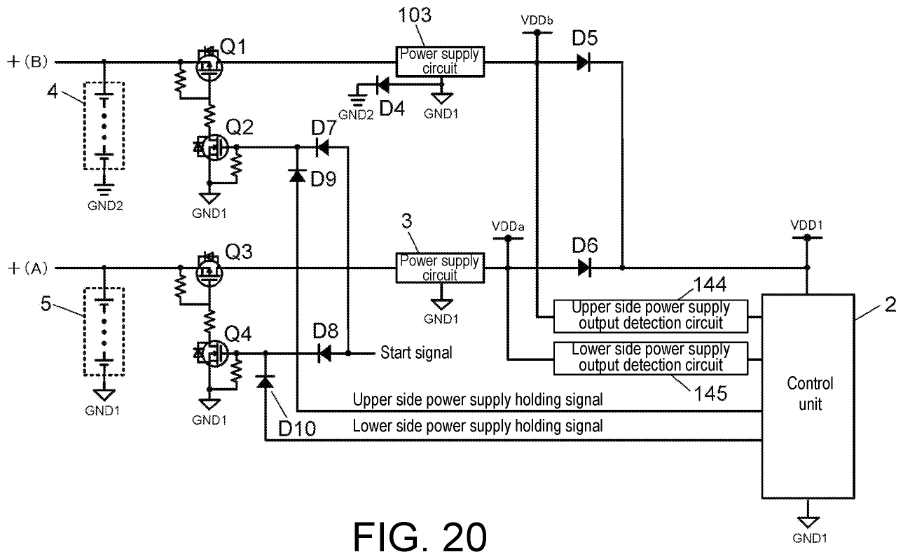

FIG. 20 is a circuit diagram of the part of the battery pack 10J related to the selection of the power supply circuits 3 and 103 by the control unit 2. In FIG. 20, the start signal is a high level signal, which is temporarily input when the operation switch 12 (remaining capacity display switch) is pressed or when electric device body is connected. The start signal is input to the gates of switching elements Q2 and Q4 via diodes D7 and D8, and the switching elements Q2 and Q4 are turned on, such that switching elements Q1 and Q3 are turned on, and the power supply circuits 3 and 103 are started. By starting the two power supply circuits 3 and 103 before selecting one of the power supply circuits 3 and 103, the control unit 2 may confirm whether or not the power supply circuits 3 and 103 are working normally via an upper side power supply output detection circuit 144 and a lower side power supply output detection circuit 145 to be described later. When both the power supply circuits 3 and 103 are not operating normally, the control unit 2 may output an abnormal signal via the LD terminal and the LS terminal.

The control unit 2, which has received power supply from the power supply circuits 3 and 103, inputs high level upper side power supply holding signal and lower side power supply holding signal to the gates of the switching elements Q2 and Q4 via diodes D9 and D10 at startup. As a result, even if there is no input of start signal, the switching elements Q2 and Q4 are maintained in the ON state, and the power supply circuits 3 and 103 are maintained in the ON state.

The control unit 2 may stop either of the power supply circuits 3 and 103 by stopping either of the upper side power supply holding signal and the lower side power supply holding signal (set to low level).

In the non-connection state shown in FIG. 14 (A), the control unit 2 may stop one of the power supply circuits that operates by the power supply from the one with a smaller output voltage from the upper side cell unit 4 and the lower side cell unit 5. Thus, not only can the power consumption be suppressed, but also an imbalance of voltages between the upper side cell unit 4 and the lower side cell unit 5 in the non-connection state can be reduced.

In the parallel connection state shown in FIG. 14 (B), the control unit 2 may stop either of the power supply circuits 3 and 103. Thus, power consumption can be suppressed.

In the series connection state shown in FIG. 14 (C), the control unit 2 may stop the power supply circuit 3 that receives power supply only from the lower side cell unit 5. Thus, not only can the power consumption be suppressed, but also the occurrence of an imbalance of voltages between the upper side cell unit 4 and the lower side cell unit 5 in a series connection state can be suppressed by the power supply circuit 103 that receives power supply from both the upper side cell unit 4 and the lower side cell unit 5.

When either of the power supply circuits 3 and 103 is stopped, the control unit 2 may make it a condition that the output voltages of the power supply circuits 3 and 103 are normal. Accordingly, it is possible to suppress the risk that the power supply cannot be maintained in the case when one of the power supply circuits 3 and 103 is stopped, the output voltage of the other becomes abnormal.

The control unit 2 monitors the output voltages of the power supply circuits 3 and 103 via the upper side power supply output detection circuit 144 and the lower side power supply output detection circuit 145.

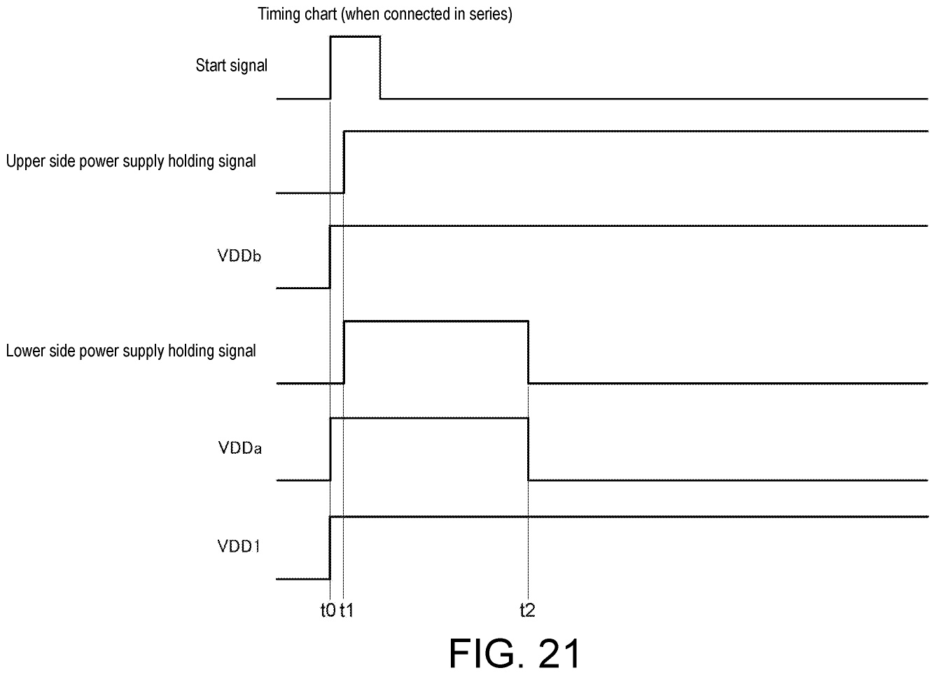

FIG. 21 is a timing chart showing an operation example of the circuit of FIG. 20 in a series connection state. When the start signal is input at time to, an output voltage VDDa of the power supply circuit 3, an output voltage VDDb of the power supply circuit 103, and the power supply voltage VDD1 of the control unit 2 rise. When the power supply voltage VDD1 rises, the control unit 2 starts, and the control unit 2 outputs the upper side power supply holding signal and the lower side power supply holding signal (set to high level) at time t1. The control unit 2 detects the output voltage VDDa of the power supply circuit 3 and the output voltage VDDb of the power supply circuit 103, and stops the lower side power supply holding signal (set to low level) at time t2 if both are normal. When the lower side power supply holding signal stops, the power supply circuit 3 stops and the output voltage VDDa of the power supply circuit 3 stops. Moreover, for example, when there is no discharge for a predetermined time or the operation of the operation switch 12, the control unit 2 further stops the upper side power supply holding signal, such that the power supply circuit 103 may also be stopped and turned off. Accordingly, power consumption can be suppressed. Moreover, the used power supply circuit may be switched every time a predetermined time elapses.

According to this embodiment, even if one of the upper side cell unit 4 and the lower side cell unit 5 fails, or one of the power supply circuits 3 and 103 fails, power supply to the control unit 2 may be maintained, and control may be maintained.

FIGS. 22 (A) to (D) are circuit diagrams showing examples 1 to 4 of level shift circuits. The circuits of FIGS. 22 (A) and (C) are examples using three switching elements, and the circuits of FIGS. 22 (B) and (D) are examples using one photoelectric coupler. FIGS. 22 (A) and (B) show examples of level shift circuits when signals are transmitted from the circuit operating based on GND2 to the circuit operating based on GND1, and FIGS. 22 (C) and (D) show examples of level shift circuits when signals are transmitted from the circuit operating based on GND1 to the circuit operating based on GND2. In any of these example, the voltage level of the input signal is inverted and output. That is, when the input signal is at a high level, the output signal is at a low level. When the input signal is at a low level, the output signal is at a high level.

The present invention has been described by taking the embodiments as examples, but those skilled in the art will understand that various modifications may be made to each component and each processing procedure of the embodiments within the scope of the claims. Hereinafter, modification examples are involved.

The step-down method performed by the power supply circuits 3 and 103 is not limited to one step, but may be two steps. For example, the power supply circuit 3 may be configured to once step down the input voltage (for example, 18V, 36V or 54V) to an intermediate voltage (for example, 12V), and then further step down the intermediate voltage to the power supply voltage VDD (for example, 5V).

In the embodiment, the voltage, current, number of cell units, and the like exemplified as specific numerical values do not limit the scope of the present invention in any way, and may be arbitrarily changed according to the required specifications.

The electric device body of the present invention is not limited to the impact driver exemplified in the above embodiments, but may be a power tool or working machine other than the impact driver, or an electric device other than a power tool or a working machine, such as a radio.

In embodiment 7, a configuration may also be adopted in which power is supplied to the power supply circuits 3 and 103 only from only one of the upper side cell unit 4 and the lower side cell unit 5.

### REFERENCE SIGNS LIST

1□1A□1B Electric device

2 Control unit

3 Power supply circuit (power supply circuit unit)

4 Upper side cell unit (first cell unit)

5 Lower side cell unit (second cell unit)

6 Upper side plus terminal (first plus terminal)

7 Lower side plus terminal (second plus terminal)

8 Upper side minus terminal (first minus terminal)

9 Lower side minus terminal (second minus terminal)

10, 10A-10D Battery pack

10E First circuit

10F Second circuit

10G Third circuit

10H, 10J Battery pack

11 Display unit

12 Operation switch

13 Upper + terminal voltage detection circuit

14 Upper side cell unit protection IC

15 Lower side cell unit protection IC

16 Terminal part

17 Current detection circuit

18 Cell temperature detection unit

19, 20 Cell voltage information output unit

21, 22 Fuse

23 Discharge prohibition signal output unit

24 Charge prohibition signal output unit

25 Intermediate cell unit (third cell unit)

26 Intermediate plus terminal (third plus terminal)

27 Intermediate minus terminal (third minus terminal)

28 Communication circuit

30, 30A, 30B Electric device body

33 Control unit

34 Power supply circuit

35 Battery voltage detection circuit

36 Switch state detection circuit

37 Current detection circuit

39 Housing

39a Body part

39b Handle part

39c Battery pack mounting part

40 Motor (driving part)

41 Switching element

42 Trigger switch (main switch)

44 Plus terminal

45 Minus terminal

46 Shorting bar

47 Plus terminal

48 Minus terminal

49, 50 Shorting bar

51 Power supply circuit

52 Control unit

53 Battery voltage detection circuit

54 Current detection circuit

60 AC power supply

73, 74 OR gate

102 Control unit

103 Power supply circuit

119 Cell voltage information output unit

123 Discharge prohibition signal output unit

124 Charge prohibition signal output unit

144 Upper side power supply output detection circuit

145 Lower side power supply output detection circuit

D1-D10 Diode

Q1-Q4 Switching element

R1, R3, R4 Resistor

1. A battery pack, comprising:
a first cell unit and a second cell unit, each having a plurality of battery cells connected in series with each other and configured to be capable of switching their connection states;
a control unit; and
a power supply circuit unit configured to supply a power supply voltage to the control unit,
wherein the battery pack has a first circuit part for connecting a positive electrode of a cell unit of one of the first cell unit and the second cell unit with the power supply circuit unit; and a second circuit part for connecting a negative electrode of a cell unit of the other of the first cell unit and the second cell unit with the power supply circuit unit,
wherein a ground potential of the control unit and that of one of the first cell unit and the second cell unit are common,
the ground potential of the control unit and that of the other of the first cell unit and the second cell unit are different, and
the battery pack has a level shift circuit for responding to a difference in ground potential in a path for sending information of the other of the first cell unit and the second cell unit to the control unit.

2. The battery pack according to claim 1,
wherein the connection state includes a series connection state in which the first cell unit and the second cell unit are connected in series with each other, and
the power supply circuit unit is configured to, in the series connection state, be electrically connected with a positive electrode of a cell unit of one of the first cell unit and the second cell unit and a negative electrode of a cell unit of the other of the first cell unit and the second cell unit and supply the power supply voltage to the control unit.

3. The battery pack according to claim 2,
wherein the power supply circuit unit is configured to, in the series connection state, be electrically connected with a positive electrode of a cell unit of one of the first cell unit and the second cell unit located on a high voltage side and a negative electrode of a cell unit of the other located on a low voltage side and supply the power supply voltage to the control unit.

4. The battery pack according to claim 2,
wherein the connection state includes a parallel connection state in which the first cell unit and the second cell unit are connected in parallel with each other, and
the power supply circuit unit is configured to, in the parallel connection state, be electrically connected with a positive electrode and a negative electrode of a cell unit of both the first cell unit and the second cell unit and supply the power supply voltage to the control unit.

5. The battery pack according to claim 1, comprising:
a third circuit part for connecting a negative electrode of a cell unit of one of the first cell unit and the second cell unit with the power supply circuit unit.

6. The battery pack according to claim 2,
wherein the connection state includes a cut-off state in which the first cell unit and the second cell unit are separated from each other, and
the power supply circuit unit is configured to, in the cut-off state, be electrically connected with a positive electrode and a negative electrode of a cell unit of one of the first cell unit and the second cell unit only, or a positive electrode and a negative electrode of a cell unit of both the first cell unit and the second cell unit and supply the power supply voltage to the control unit.

7. (canceled)

8. The battery pack according to claim 2,
wherein the connection state includes a cut-off state in which the first cell unit and the second cell unit are separated from each other, and
the power supply circuit unit is configured not to, in the cut-off state, be electrically connected with any of the first cell unit and the second cell unit.

9. (canceled)

10. A battery pack, comprising:
a plurality of cell units, each having a plurality of battery cells connected in series with each other and configured to be capable of switching between a series connection state of being connected in series with each other, and a parallel connection state of being connected in parallel with each other;
a control unit; and
a power supply circuit unit for supplying a power supply voltage to the control unit,
wherein the power supply circuit unit is configured to, in the series connection state, be electrically connected with a positive electrode of a cell unit of the plurality of cell units located at a highest voltage side and a negative electrode of a cell unit of the other cell unit located at a lowest voltage side and supply the power supply voltage to the control unit, and
the power supply circuit unit is configured to, in the parallel connection state, be electrically connected with a positive electrode and a negative electrode of at least one cell unit of the plurality of cell units and supply the power supply voltage to the control unit.

11. (canceled)

12. A battery pack, comprising:
a first cell unit and a second cell unit, each having a plurality of battery cells connected in series with each other and configured to be capable of switching their connection states;
a first control unit and a second control unit respectively provided for the first cell unit and the second cell unit; and
a first power supply circuit unit and a second power supply circuit unit for supplying a power supply voltage to the first control unit and the second control unit respectively,
wherein a ground potential of the first control unit and that of the second control unit are different, and
the battery pack has a level shift circuit for responding to a difference in ground potential between the first control unit and the second control unit.

13. The battery pack according to claim 12,
wherein the level shift circuit is provided in at least one of a communication path in which the first control unit and the second control unit communicate with each other and a path in which a signal is sent from the first control unit or the second control unit to an electric device body connected to the battery pack.

14. The battery pack according to claim 12, comprising:
a remaining capacity display unit,
wherein one of the first control unit and the second control unit controls display of the remaining capacity display unit based on a voltage of one of the first cell unit and the second cell unit, one that supplies power to itself or has a small voltage, regardless of a voltage of the other.

15. (canceled)

16. The battery pack according to claim 1,
wherein the connection state is changeable by connecting the battery pack to the electric device body.

17. An electric device, comprising:
a battery pack according to claim 1, and
an electric device body comprising a battery pack mounting part capable of mounting the battery pack, and a driving part driven by the battery pack mounted on the battery pack mounting part.

18. An electric device, comprising:
a battery pack according to claim 10, and
an electric device body comprising a battery pack mounting part capable of mounting the battery pack, and a driving part driven by the battery pack mounted on the battery pack mounting part.

19. An electric device, comprising:
a battery pack according to claim 12, and
an electric device body comprising a battery pack mounting part capable of mounting the battery pack, and a driving part driven by the battery pack mounted on the battery pack mounting part.

20. The battery pack according to claim 10,
wherein the plurality of cell units is configured to be capable of switching a cut-off state in which the first cell unit and the second cell unit are separated from each other,
wherein the power supply circuit unit is configured to, in the cut-off state, be electrically connected with a positive electrode and a negative electrode of a cell unit of the plurality of cell units or positive electrodes and negative electrodes of the plurality of cell units and supply the power supply voltage to the control unit.

21. The battery pack according to claim 10,
wherein the plurality of cell units is configured to be capable of switching a cut-off state in which the first cell unit and the second cell unit are separated from each other,
the power supply circuit unit is configured not to, in the cut-off state, be electrically connected with any of the first cell unit and the second cell unit.

22. An electric device, comprising:
an electric device body comprising a battery pack mounting part capable of mounting the battery pack according to claim 1, and a driving part driven by the battery pack mounted on the battery pack mounting part.

23. An electric device, comprising:
an electric device body comprising a battery pack mounting part capable of mounting the battery pack according to claim 10, and a driving part driven by the battery pack mounted on the battery pack mounting part.

24. An electric device, comprising:
an electric device body comprising a battery pack mounting part capable of mounting the battery pack according to claim 12, and a driving part driven by the battery pack mounted on the battery pack mounting part.
